(19) United States
(12) Patent Application Publication
(10) Pub. No.: US 2011/0223577 A1
(43) Pub. Date: Sep. 15, 2011

(54) Apparatus and method for multiple sensory imprinting learning systems using visual, auditory and kinetic stimuli

(76) Inventor: Stephen M. Simon, San Clemente, CA (US)

(21) Appl. No.: 12/927,588

(22) Filed: Nov. 18, 2010

Related U.S. Application Data
(63) Continuation-in-part of application No. 12/655,501, filed on Dec. 30, 2009.
(60) Provisional application No. 61/280,303, filed on Nov. 2, 2009.

(51) Int. Cl. G09B 25/00

(52) U.S. Cl. 434/365

(57) ABSTRACT

An apparatus and method for impact activity learning includes a touch sensing element and display operating in accordance with a controller and display driver together with a sound circuit and image projector. The entire system housed in an impact receiving object such as a punching bag or floor mat. The user is prompted by a set of displayed image segments in response to which the user punches or otherwise impacts the apparatus to elicit an audible and visual response from the apparatus.

### CROSS-REFERENCE TO RELATED APPLICATION

This application is a continuation-in-part of copending application Ser. No. 12/655,501 filed Dec. 30, 2009 in the name of Stephen M. Simon entitled APPARATUS AND METHOD FOR IMPACT ACTIVITY LEARNING SYSTEM which application claims the benefit of and priority under 35 U.S.C. 119(e) of U.S. Provisional Patent Application No. 61/280,303 entitled APPARATUS AND METHOD FOR IMPACT ACTIVITY LEARNING SYSTEM filed Nov. 2, 2009 in the name of Stephen M. Simon, the disclosures of both are hereby incorporated herein by reference.

### FIELD OF THE INVENTION

This invention relates generally to learning apparatus and methods and particularly to those which address learning difficulties and disabilities associated with conditions such as dyslexia or the like.

### BACKGROUND OF THE INVENTION

Various learning difficulties have been encountered by students and other learners through the years which have impeded the learning capabilities of persons to an extent which is disproportionate to the complexity of the subject matter. One of the most vexing types of learning difficulties which have been encountered is the learning difficulties generally described as dyslexia. Dyslexics often see symbols such as printed letters or the like in an unnatural orientation or relationship to other symbols. Practitioners in the art have endeavored to overcome these difficulties with limited success.

In addition to dyslexia, a significant number of other learning difficulties arise in teaching skills associated with symbol-related skills such as spelling, reading, mathematics and the like. Often, the difficulty tends to center upon the skills required to correctly recognize a visually presented symbol or set of symbols. Overcoming these difficulties often requires a prohibitive amount of teacher assistance. In addition, the traditional methods applied to such learning difficulties are usually rather tedious and boring.

While the prior art teaching systems and methods have provided some benefits for learners, there remains nonetheless a continuing and unresolved need in the art for improved teaching methods and apparatus which assist learners having symbol-related learning difficulties.

### SUMMARY OF THE INVENTION

Accordingly, it is a general object of the present invention to provide an improved method and apparatus for learning systems. It is a more particular object of the present invention to provide a multiple sensory imprinting learning system having particular benefit for learning difficulty impaired students.

The present invention apparatus and method for multiple sensory imprinting learning systems utilizes a combination of simultaneous and interacting visual, auditory and kinetic stimuli in association with presentation of learning materials which is particularly effective in assisting students with a broad array of symbol recognition type difficulties such as dyslexia or the like. The apparatus and method utilizes physical impact sensory and kinetic activities which yield large motor tactile learning together with associated visual and auditory stimuli. In the basic operation of the present invention apparatus and method, the system presents a symbol or image segment such as a letter upon a display. The learner interacts physically in a large motor action as well as visually with the displayed symbol by punching the displayed symbol. For example, the symbol may be presented upon a punching bag, in which case, the learner responds by punching the symbol upon the punching bag at the supporting display screen while pronouncing the letter or other symbol. The apparatus then sounds the same letter. This process is repeated as the user responds to each presented letter or symbol upon the display with a punch and simultaneous verbal articulation of the letter or symbol while the apparatus also sounds the displayed letter or symbol. In some apparatus, the system responds to a completed symbol set (ie a completed word) and audibly speaks the word and projects the completed word upon a wall or convenient surface positioned behind and slightly above the learner.

Thus, in accordance with the present invention, there is provided a method of impact learning activity, the method comprising the steps of; selecting a set of image segments which image segments combine to form a complete image set; displaying the first image segment of the set of image segments upon an impact responsive display; sensing an impact upon the impact responsive display; sounding an audible form of the first image segment; displaying the next image segment of the set of image segments; repeating the steps of sensing an impact, sounding and sequentially displaying the next image segment from the set of image segments until the selected set of image segments is complete and displayed; sounding an audible form of the complete set of image segments; and projecting the complete set of image segments upon a surface for viewing.

From another perspective, the present invention provides a method of impact learning activity, the method comprising the steps of selecting a set of image segments which image segments combined form a complete image set; displaying the first image segment upon an impact responsive display; sensing an impact upon the impact responsive display sounding an audible form of the first image segment; displaying the next image segment; repeating the steps of sensing an impact, sounding and displaying the next image segment until the selected set of images is complete and displayed; sounding an audible form of the complete set of image segments; and projecting the complete set of image segments upon a surface for viewing.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a block diagram of the present invention learning systems;

FIG. 2 sets forth a front view of an illustrative apparatus utilized in the present invention learning system;

FIG. 3 sets forth a partial front view of the apparatus of FIG. 2 utilizing a different symbol set;

FIG. 4 sets forth a hanging punching bag embodiment of the present invention learning system;

FIG. 5 sets forth a perspective view of a floor mat embodiment of the present invention learning system;

FIG. 6 sets forth a flow diagram of the operation of the present invention learning system method;

FIG. 7 sets forth a perspective view of a game unit embodiment of the present invention learning system;

FIG. 8 sets forth a block diagram of the game unit embodiment of the present invention learning system;

FIG. 9 sets forth a perspective view of a punch drum embodiment of the present invention learning system;

FIG. 10 sets forth an alternate embodiment of the punch drum learning system of the present invention;

FIG. 11 sets forth a further alternate embodiment of the punch drum embodiment of the present invention learning system;

FIG. 12 sets forth a perspective view of a punch screen embodiment of the present invention learning system;

FIG. 13 sets forth a section view of the punch screen shown in FIG. 12 of the present invention learning system;

FIG. 14 sets forth a flexible curtain embodiment of the present invention learning system; and

FIGS. 15A through 15G set forth tables of case study results using the present invention learning method and apparatus.

### DESCRIPTION OF THE PREFERRED EMBODIMENTS

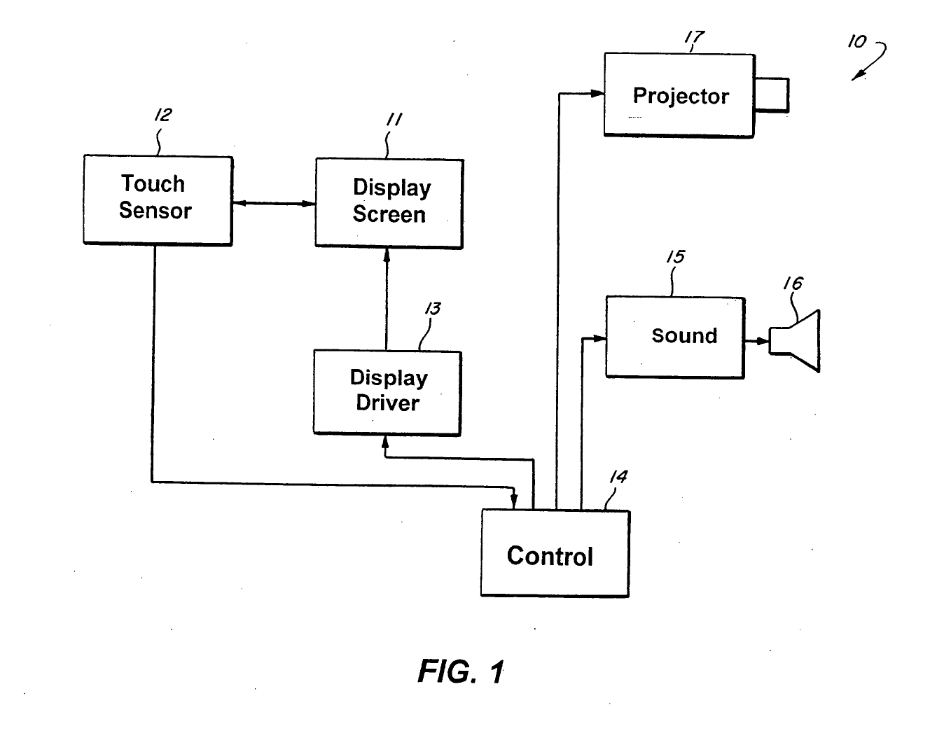

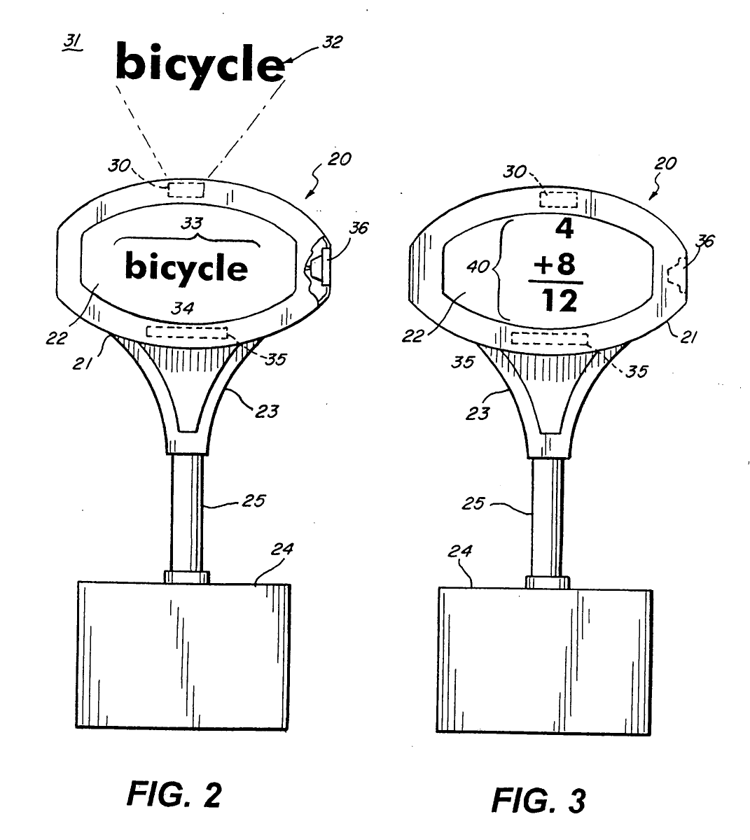

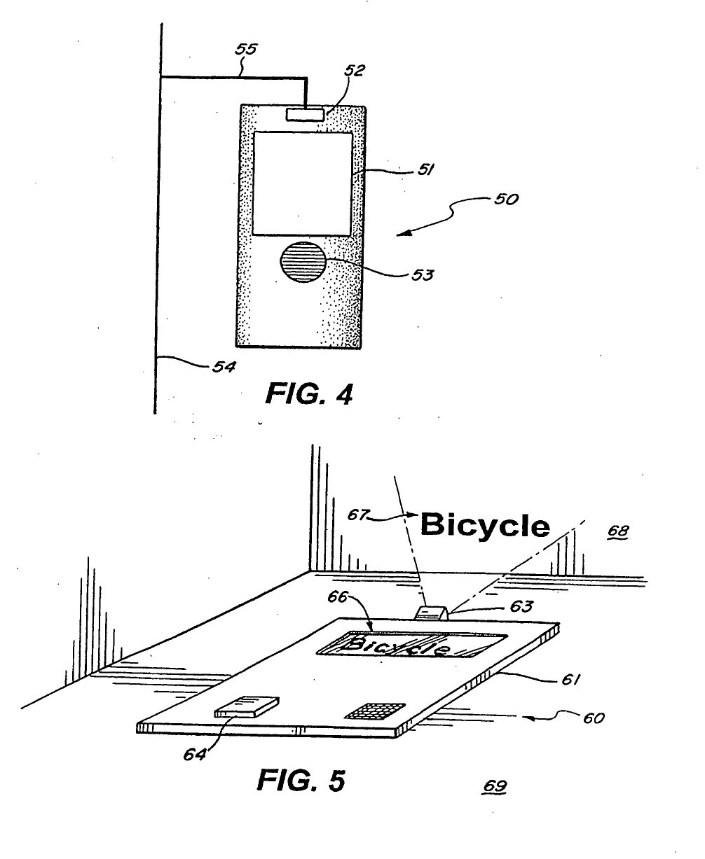

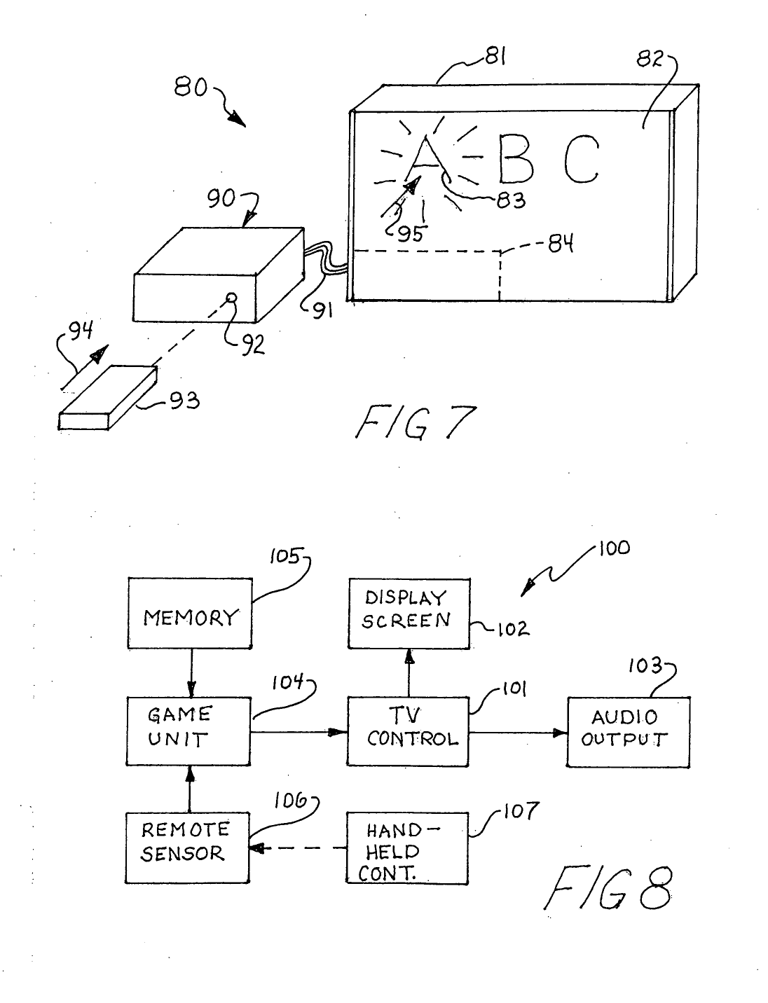

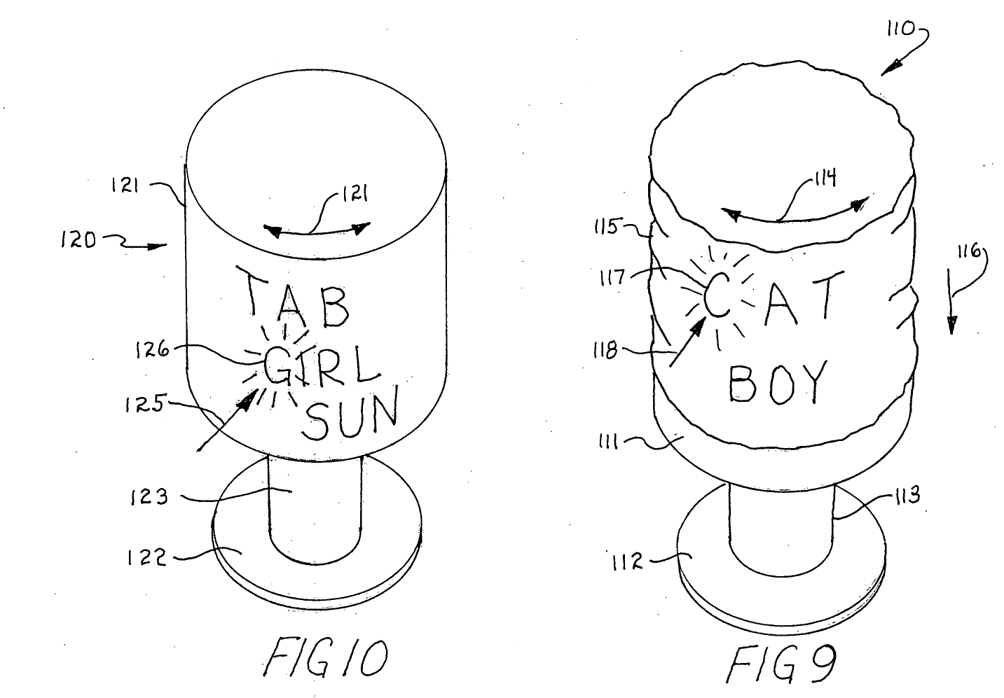

FIG. 1 sets forth a basic block diagram of the present invention apparatus for impact activity learning systems generally referenced by numeral 10. It will be apparent from the figures below that system 10 may be employed in conjunction with a variety of host apparatus including by way of example and not limitation the punching bag shown in FIG. 4, the resilient target shown in FIGS. 2 and 3, the floor mat shown in FIG. 5, as well as the game unit embodiment of FIGS. 7 and 8, the drum embodiment of FIGS. 9 through 11, the punch screen of FIGS. 12 and 13 and the curtain embodiment of FIG. 14.

More specifically returning to FIG. 1, system 10 includes a display screen 11 having a display driver 13 operatively coupled thereto. A touch sensor 12 is operatively coupled to display screen 11. A controller 14 is operatively coupled to touch sensor 12 and display driver 13. A sound circuit 15 including a speaker 16 is operated by controller 14. A projector 17 constructed in accordance with conventional fabrication techniques is controlled by controller 14. Display screen 11 and touch sensor 12 may be fabricated in accordance with FIG. 13.

In operation, impacts against display screen 11 are sensed by touch sensor 12 and produce a signal input to controller 14. Controller 14 in response to touch sensor 12 produces an audible output signal which is applied to sound circuit 15 and speaker 16. Operation of the present invention system is initiated as controller 14 outputs a symbol such as a letter which is applied to display driver 13. Display driver 13 responds by displaying the selected symbol such as a letter upon display screen 11. Thus, in the anticipated operation of the present invention apparatus and method, controller 14 selects a letter or symbol which is applied to display driver 13 producing a segment image of the letter or symbol upon display screen 11. Thereafter, and in accordance with the present invention learning method, the user punches or otherwise impacts system 10 while speaking the letter or symbol. This punch or impact is sensed by sensor 12 and produces a signal at controller 14. In response to the input from sensor 12, controller 14 produces an audio signal applied to sound output 15 which plays a speech of the letter or symbol through speaker 16. Thereafter controller 14 selects the next image segment or symbol such as the next letter in a word to be applied to display driver 13. In response, display driver 13 displays the next image segment or symbol such as the next letter of a word upon display screen 11. The user then voices the displayed letter while punching system 10 and the process repeats producing an output from touch sensor 12 to which controller 14 responds by audiblizing the next letter through sound system 15 and speaker 16. This process is repetitive as the user continues to respond to display screen 11 by punching system 10 and speaking the displayed letter or other symbol until a completed symbol set such as a completely spelled word is displayed upon display screen 11. Thereafter, controller 14 drives projector 17 to display a projected image of the word of symbol set upon a conveniently located surface such as a wall or the like.

FIG. 2 sets forth an illustrative impact receiving target 20 having a heavily weighted base 24, a support post 25 and a spring support 23 all of which combine to support a frame 21. Frame 21 further supports a display screen 22, a controller circuit 35 and a projector 30. Frame 21 further supports a speaker 36. Projector 30 and speaker 36 are coupled to circuit 35 in the general manner shown in FIG. 1. Display screen 22 is fabricated utilizing an LCD display screen or other suitable apparatus. Of particular advantage is the utilization of a touch responsive screen. Otherwise a separate impact sensor such as a conventional momentum switch may be provided to sense impacts against display screen 22.

In accordance with the present invention, display screen 22 is shown displaying an image set 33 which will be recognized as comprising the letters which spell the word “bicycle”. The letters of bicycle each define image segments of the completed image provided by image set 33.

FIG. 3 sets forth a partial front view of apparatus 20 utilizing a different image set 40. Image set 40 will be shown to have numeric image segments such as image segments 41. It will be apparent to those skilled in the art that the utilization of apparatus 20 in association with arithmetic operations rather than spelling activities can be operated in precisely the same manner as the above described method associated with words. In fact, virtually any symbol set or image set may be utilized without departing from the spirit and scope of the present invention.

FIG. 4 sets forth a simplified diagram of a further alternate embodiment of the present invention apparatus and method for impact activities learning systems generally referenced by numeral 50. System 50 is preferably fabricated to provide a punching bag which is hung from a wall 54 by a conventional punching bag support 55. Thus, it will be apparent that punching bag 50 supports a display screen 51, a projector 52 and a sound output 53. It will be further apparent to those skilled in the art that the embodiment of FIG. 4 utilizes a system in accordance with FIG. 1 set forth and described above. The convenience of having a punching bag for system 50 is found in the interest and amusement value associated with punching bags and the synergistic cooperation of the punching bag as host apparatus for the present invention impact activity learning systems. In use of a punching bag to support display screen 51 provides substantial impact absorption and protection for display screen 51.

FIG. 5 sets forth a perspective view of a still further alternate embodiment of the present invention impact activity apparatus and method in which a floor 69 and wall 68 are provided with intersecting generally flat surfaces such as in a room or suitable dwelling. In accordance with the present invention, a target mat 60 preferably formed of a resilient or cushioned material supports a multiple display screen display unit 62. In the preferred fabrication of the present invention, floor mat 61 supports a plurality of LCD screens or the like to provide a larger and more easily observed display screen. A controller 64 and an audio output 65 are also supported within or upon mat 61. Mat 61 further supports a projector 63 which is directed toward wall 68 to produce a projected image 67. Display 62 is shown in FIG. 5 having an image set 66 displayed thereon. It will be apparent to those skilled in the art that displayed image set 66 and projected image 67 comprise the letters forming the letters “bicycle”. However, it will be equally apparent to those skilled in the art however that mathematical symbols or other languages or other symbols and images associated with learning activities may be utilized in the present invention system without departing from the spirit and scope thereof.

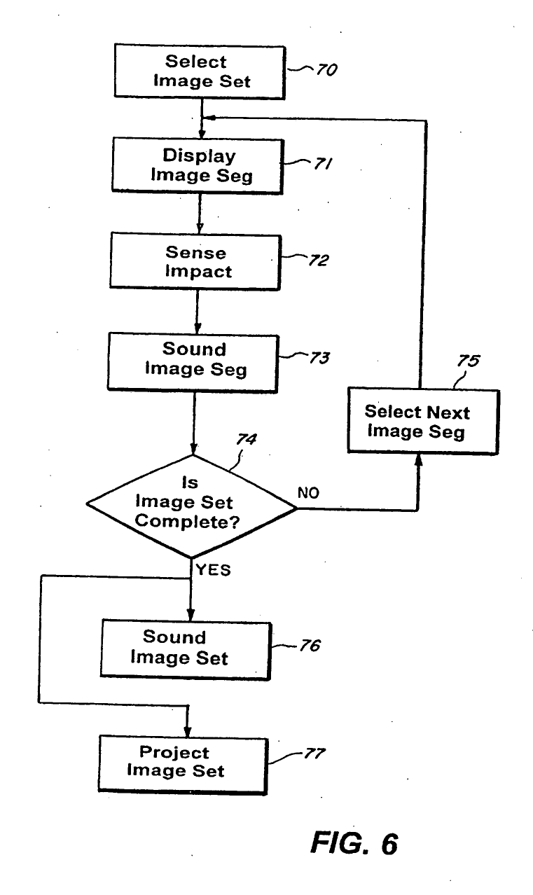

FIG. 6 sets forth a flow diagram of the method utilized in the present invention apparatus and method for impact activity learning systems. The method is initiated at a step 70 in which an image set such as a word or mathematical expression is selected. Thereafter, the method moves to step 71 in which a single image segment such as the first letter of a word is displayed. Thereafter, the system moves to a step 72 in which a sensing of the punch of the learner is detected. Once the impact is sensed or detected, the system moves to a step 73 in which the image segment such as the letter of a word is audiblized as audible sound. Thereafter, at step 74, a determination is made is to whether the displayed image set is complete. If the image set is not complete such as an incomplete word spelling, the system moves to step 75 selecting the next image segment within image set. In the case of a word this would be the next letter in the word. From step 75, the system returns to step 71 displaying the next image segment in the image set. The system then proceeds again through steps 72, 73 and at step 74 determines once again whether the image set is complete. If still not complete, the system returns to step 75 selecting the next image segment such as the next letter in the to-be-spelled word and thereafter returns to step 71. This cyclical process through steps 71, 72, 73, 74 and 75 continues to cycle until a determination is made at step 74 that the image set is complete. Once again in the example of spelling this would be constituted by a completely spelled word which is now displayed in its entirety. With a complete set of image segments the system now moves to step 76 in which the complete image set is audiblized and simultaneously a projected image of the image set is projected upon a convenient display surface such as a wall.

Thus, in operation in the environment of a spelling lesson, the system selects a word at step 70 and displays the first letter of the word at step 71. The user responds by punching the apparatus while simultaneously voicing the displayed letter. This impact is sensed at step 72 and the system also audiblizes the letter at step 73. At step 74, a determination is made as to whether a complete word has been spelled out. If not, the system moves to step 75 selecting the next letter of the word for display at step 71. The process cycles through each letter of the word with the user providing audiblizing and punching impact in response to each new displayed letter. Once the complete word has been spelled and is displayed, the system then audiblizes the entire word while projecting the completed word upon the nearby wall surface or the like.

FIG. 7 sets forth a perspective view of a game unit embodiment of the present invention learning system generally referenced by numeral 80. Game unit learning system 80 includes a display 81 having a generally planar display screen 82 together with a control circuit 84. Display 81 may, for example, be provided by a conventional television receiver of the type capable of displaying images upon screen 82 in accordance with received video information. In such case, control circuit 84 will be understood to include conventional television signal receiving and processing circuitry together with conventional display drivers suitable for providing images upon screen 82. In the anticipated fabrication of display screen 82, any of the available conventional displays such as the commonly used liquid crystal displays or the like may be utilized. Game unit system 80 further includes a game controller 90 having a plurality of connecting cables 91 coupling controller 90 to circuit 84 within display 81. Game controller 90 further includes a remote signal receiver 92. Game controller 90 is fabricated in accordance with conventional game fabrication techniques and thus, may for example include any of the currently available popular game units utilized in combination with television receivers. Several brands of such game units are currently available in the market place including game units manufactured and sold under the Wii trademark or Xbox trademark or the like. System 80 further includes a handheld controller 93 which is also fabricated in accordance with conventional fabrication techniques and thus includes conventional signal transmission apparatus suitable for providing signal communication between controller 93 and game controller 90 via signal receiver 92. In most game unit fabrications, this communication between handheld controller 93 and game controller 90 is provided by infrared or IR transmission apparatus. In further accordance with conventional fabrication techniques, game controller 90 includes internal memory apparatus for storing operational instructions to be used by game controller 90 in providing input signals to display 81. In further accordance with conventional fabrication techniques, movement of handheld controller 93 as well as manipulation of control buttons upon button 93 are utilized in providing game play inputs to game controller 90.

In accordance with the present invention, game controller 90 includes the above-described impact learning system in accordance with which a plurality of symbols such as alphabetic characters 83 are caused to be imaged upon display screen 82. In further accordance with the present invention, the stored instruction set within game controller 90 interprets certain movements of handheld controller 93 as impact or punching movements utilized in accordance with the above-described learning system to provide corresponding image reaction upon display screen 82. Thus, for example, rapid movement of handheld controller 93 forwardly in the manner indicated by arrow 94 produces a corresponding image reaction simulating a “punch” 95 impacting alphabetic character 93. In the preferred fabrication the present invention, game controller 90 causes this simulated impact to produce a distortion or response by the impacted alphanumeric character.

Thus, in accordance with the present invention, game unit learning system 80 is operated as the user is presented with one or more alphanumeric characters upon display screen 82 in response to which the user employs handheld controller 93 in simulation of the above-described activity and creates a simulated punching impact of the alphanumeric character. In this manner, the user is able to repeatedly “punch” a designated character upon display screen 82 through manipulation of handheld controller 93 and engage in the above-described multi-sensory impact learning system. It will be apparent to those skilled in the art that a variety of different game activities utilizing the punching action of the present invention learning system may be simulated by game system 80.

FIG. 8 sets forth a block diagram of a game unit learning system of the type set forth in FIG. 7 which is generally referenced by numeral 100. System 100 includes a game unit 104 having an associated memory 105 operatively coupled thereto. Game unit 104 further includes a remote sensor 106 together with a handheld remote controller 107. Handheld controller 107 provides input signals to remote sensor 106 via a communication link such as infrared transmission or the like. System 100 further includes a television control circuit 101 operatively coupled to a television display screen 102. Television control 101 is further coupled to an audio output circuit 103.

In operation, game unit 104 receives instructions and information from a stored program within memory 105 and produces a plurality of input signals to TV control 101. In response, TV control 101 provides image display information for display screen 102 and audio information for audio output 103. The result is the display and output of audio visual information by system 100. In accordance with the present invention learning system, the user manipulates handheld controller 107 to provide information signals which are received by remote sensor 106 and operatively coupled to game unit 104. Thus, as described above in the example of FIG. 7, the user may move handheld controller 107 in a rapid forward punching motion to provide a corresponding input signal set to remote sensor 106. This information applied by sensor 106 to game unit 104 causes TV control 101 to configure display screen 102 in the above-described manner to respond to the punch input. Correspondingly, for increased effect, the above-described audio information utilized by the present invention learning system is outputted by television control 101 to audio output system 103. In this manner the system shown in FIGS. 7 and 8 is able to participate in the above-described learning activities.

With concurrent reference to FIGS. 7 and 8, it will be apparent to those skilled in the art the while the game unit operation is illustrated in combination with a television display, game units of the type being utilized are also operable in combination with computers and computer display screens. Correspondingly, it will apparent to those skilled in the art that the illustrated game system application of the present invention learning system applies equally well to television receivers and computing systems.

FIG. 9 sets forth a perspective view of a punch drum embodiment of the present invention generally referenced by numeral 110. Punch drum learning system 110 includes a generally cylindrical punching drum 111 supported upon a base 112 by a vertical support 113. Drum 111, base 112 and support 113 may be fabricated in accordance with conventional fabrication techniques in which drum 111 is typically covered with a resilient padding material such as foam rubber or the like. In accordance with the present invention, a flexible drum covering 115 which may for example, comprise an open plastic bag or the like is placed upon drum 111 and positioned downwardly thereon in the direction indicated by arrow 116 so as to cover some or all of the outer surface 111. In further accordance with the present invention, plastic bag 115 further includes a plurality of symbols such as alphabet characters or the like including symbol 117 which by way of example comprises a capital letter “C”.

In operation, and in accordance with the present invention learning system, punch drum embodiment 110 may be utilized to carry forward the learning system as the learner is presented with system 110 and is directed to articulate a chosen symbol such as symbol 117 by an instructor. In further accordance with the present invention learning system, the instructor requires that the learner punch the selected symbol as indicated by punch 118. This punch impacts plastic bag 115 and drum 111 as illustrated. In this manner, the learner is challenged to punch and voice the indicated symbol in the above-described impact learning operation of the present invention system. The instructor then rotates drum 111 as indicated by arrows 115 to position or present the next desired character such as the letter “A” in the word “cat”. Thereafter, the learner again speaks the letter “A” verbally while punching the letter “A” covering 115. In the anticipating learning system, the instructor then rotates drum 111 to present the letter “T” to the learner and elicits another punch against the letter “T” and verbalization of the letter out loud. Thereafter, the learner voices the completed word “cat” completing the cycle to the present invention learning activity.

It will be apparent to those skilled in the art that the utilization of punch drum system 110 may be carried forward having coverings 115 which include printed symbols thereon. Alternatively, it will be equally apparent that covering 115 may be fabricated of a material such as light colored plastic or the like which is blank or includes blank portions upon which the instructor may hand write selected symbols and carry forward the present invention learning activity.

FIG. 10 sets forth a perspective view of a further alternate embodiment of the present invention learning system generally referenced by numeral 120. It will be apparent to those skilled in the art that the punch drum apparatus shown in FIG. 10 is similar to the punch drum apparatus shown in FIG. 9. Thus, it will be equally apparent to those skilled in the art that the application of punch drum unit 120 to the present invention learning system is substantially identical to the application thereof to punch drum unit 110 in FIG. 9. Accordingly, punch drum apparatus 120 includes a generally cylindrical drum 121 preferably formed of a padded material supported upon a base 122 by a rotatable support 123. Drum 121 supports a plurality of symbols such as alphabet characters forming words or other symbol related information such as mathematical symbols and numbers in accordance with the learning material be utilized. In the example of FIG. 10, a plurality of words are presented upon the surface of drum 121. It will be apparent to those skilled in the art that in accordance with the instructor's preference drum 121 may provide pre-printed words or alternatively may include blank portion upon which the instructor writes the desired words to be utilized in the lesson.

In operation, a plurality of words including the word “girl” are printed upon drum 121. In accordance with the above-described learning system, the instructor initially directs the learners attention to letter 126 and the learner punches the letter “G” indicated by arrow 125 impacting the letter “G” and audibly voicing the letter. Thereafter the instructor sequentially directs the learner's attention to the remainder of letters within the word “girl” in response to which the punching and audiblizing sequence of the learning system are carried forward. Drum 121 may be rotated in the manner indicated by arrows 124 to properly position the desired letters or words to the learner.

FIG. 11 sets forth a further alternate embodiment of the punch drum apparatus utilized in accordance with the present invention system generally referenced by numeral 130. Punch drum apparatus 130 is substantially similar to punch drums 110 and 120 shown in FIGS. 9 and 10 above. Correspondingly, the utilization of the present invention learning system is carried forward utilizing punch drum 130 in substantially the same manner described above in conjunctions with FIGS. 9 and 10. Thus, punch drum apparatus 130 includes a generally cylindrical drum 131 supported upon a base 132 by a rotatable support 133. Punch drum apparatus 130 differs from punch drum apparatus 110 and 120 of FIGS. 9 and 10 in that a different mechanism is employed to provide symbols for presentation to the learner. In punch drum apparatus 130, a plurality of attachment areas are formed upon the outer surface of drum 131. In their preferred fabrication, the attachment areas formed on drum 131 utilize the popular hook and loop fabric attachment apparatus which facilitates repeated removal and attachment. Thus, drum 131 supports a plurality of attachment fabric bands 135 and 136 together with a plurality of attachment pads 137, 138, 139 and 140. Correspondingly, a plurality of alphabet letters 141, 142, 143 and 144 are utilized upon drum 131. Letter 141 is shown positioned for attachment upon band 135 while letters 142 and 143 are shown secured to drum 131 upon band 135. Letter 144 is shown rotated to present its attachment surface which includes a plurality of cooperating fabric attachment pads 145 and 146. It will be understood that letter 144 is illustrative of the reverse sides of letters 141, 142 and 143. As a result, letters such as letters 141 through 144 may be removably positioned upon the cooperating fabric attachment areas formed on drum 131 as desired by the instructor. In this manner, the array of letters positioned upon drum 131 may be repeatedly changed and revised. With the desired combination of letters or other symbols removably secured to drum 131, the above-described learning system may be carried forward.

FIG. 12 sets forth a perspective view of a punch screen embodiment of the present invention learning system generally referenced by numeral 150. Apparatus 150 includes a display housing 151 which supports a display screen 152 in accordance with the fabrication shown in FIG. 13. Suffice to note here that display housing 151 is configured to be supported upon a convenient wall surface by conventional attachment while display screen 152 is resiliently supported with respect to housing 151. Apparatus 150 further includes a display controller 153 which is operatively coupled to display screen 152 by a cable 154.

In operation, display controller 153 operates in response to a stored instruction set together with user inputs which are provided by a keyboard 166. In response to the stored instruction set within display controller 150 and user inputs via keyboard 166, a plurality of characters such as letters 155, 156 and 157 are display upon display screen 152. Thereafter, the above-described present invention learning system is carried forward as the instructor directs the learner to each of characters 155, 156 and 157. In response the learner punches display screen 152 in the manner indicated by arrow 158 to provide the above-described impact learning process. In accordance with the structure set forth in FIG. 13, display screen 152 is able to absorb the punch impact due to its resilient support within housing 151.

FIG. 13 sets forth a section view of apparatus 150 shown in FIG. 12. As described above, apparatus 150 includes a display housing 151 which resiliently supports a display screen 152. As is also described above, apparatus 150 includes a display controller 153 coupled to display screen 152 by a cable 154. Housing 151 includes a plurality of resilient elements such as springs 162, 163, 164 and 165 uniformly spaced within housing 151. The remaining ends of resilient elements 162 through 165 are coupled to display screen 152. Thus, display screen 152 is resiliently removable with respect to housing 151. Housing 151 is preferably secured to a convenient wall space or other suitable support using conventional attachment means. In the preferred fabrication of the present invention, a plurality of momentum switches 151, 160 and 161 are coupled to display screen 152. Momentum switches 159 through 161 are fabricated in accordance with conventional fabrication techniques and are operative to provide a signal output when disturbed from their present position as display screen 152 is moved.

In operation, as controller 153 is utilized in presenting one or more symbols such as alphabet characters or the like upon display screen 152, and as the user practices the above-described present invention learning system, a punch represented by arrow 158 impacting display screen 152 disturbs the position of display screen 152 and compresses one or more of resilient elements 162 through 165. The sudden movement of display screen 152 causes one or more of momentum switches 159 through 161 to be disturbed and thereby produce an output signal. This output signal is coupled to controller 153 and is utilized in producing a visual indication of punch impact upon display screen 152.

It will be apparent to those skilled in the art that the embodiment of the present invention characterized by a punch screen embodiment shown in FIGS. 12 and 13 is merely illustrative of a punch screen capable of displaying symbols and receiving punch impacts in order to facilitate practicing the present invention learning system. It will be equally apparent to those skilled in the art that a variety of similar structures may be utilized without departing from the spirit and scope of the present invention.

FIG. 14 sets forth a still further alternate embodiment of the present invention which may be characterized as a flexible curtain embodiment of the present invention generally referenced by numeral 170. Flexible curtain apparatus 170 includes a flexible curtain 171 supported upon a convenient support 172 by a plurality of hanging loops 173. Curtain 171 supports a plurality of symbols such as alphabet characters 180 through 185. The manner in which alphabet characters such as characters 180 through 185 are supported upon curtain 171 may for example include simply printing characters upon the surface of curtain 171. Alternatively, characters such as characters 180 through 185 may be preprinted or preformed upon the surface of curtain 171. By way of further variation, 171 may utilize a plurality of fabric attachment elements such as attachment pads 174 and 175. In this event, a plurality of characters such as character 176 are fabricated having cooperating fabric attachment portions 177 on the rear surfaces thereof. In this utilization, letter 176 is rotated as indicated by arrow 178 and moved in the direction indicated by arrow 179 to position character 176 overlying fabric attachment pads 174 and 175 to removably secure character 176 upon curtain 171.

Utilizing any of the above-described methods of placing characters upon curtain 171, the instructor then instructs the learner to punch a selected character in the manner indicated by arrow 186. As the learner punches the selected character, curtain 171 deforms producing an impact area 187. In this manner, curtain apparatus 170 may be utilized in practicing the present invention learning system as described above.

In this manner, the user simultaneously employs audio, visual, tactile and physical activity in response to each letter. It has been found that this is particularly advantageous for imprinting the symbols such as letters of words or mathematical symbols or other learning activities symbols to a degree not obtained by simple display and audiblizing. The present invention system is operable in a variety of embodiments with considerable advantage.

It should be noted that the present invention apparatus and method is an imprinting system which is directed aiding the learner in recognition. The inventive system provides substantial advantages of the prior art systems which employ a question and answer format in which the learner is given a correct or incorrect indication for each response.

The present invention addresses the multisensory techniques that are used at times for all students and frequently for students with learning disabilities. Multisensory techniques and strategies stimulate learning by engaging students on multiple levels. Learning-disabled students have learning differences in one or more areas of spelling, reading, math, listening comprehension, and expressive language. When students are taught using techniques consistent with their learning styles, they learn more easily, quickly & can retain and apply concepts more readily to future learning. The present invention implements these techniques as it helps learners to use all of these senses to collect information about a task and link that information to solve the task. These multisensory techniques that are all inherent in the present invention enable learners to use their personal areas of strength to help them learn.

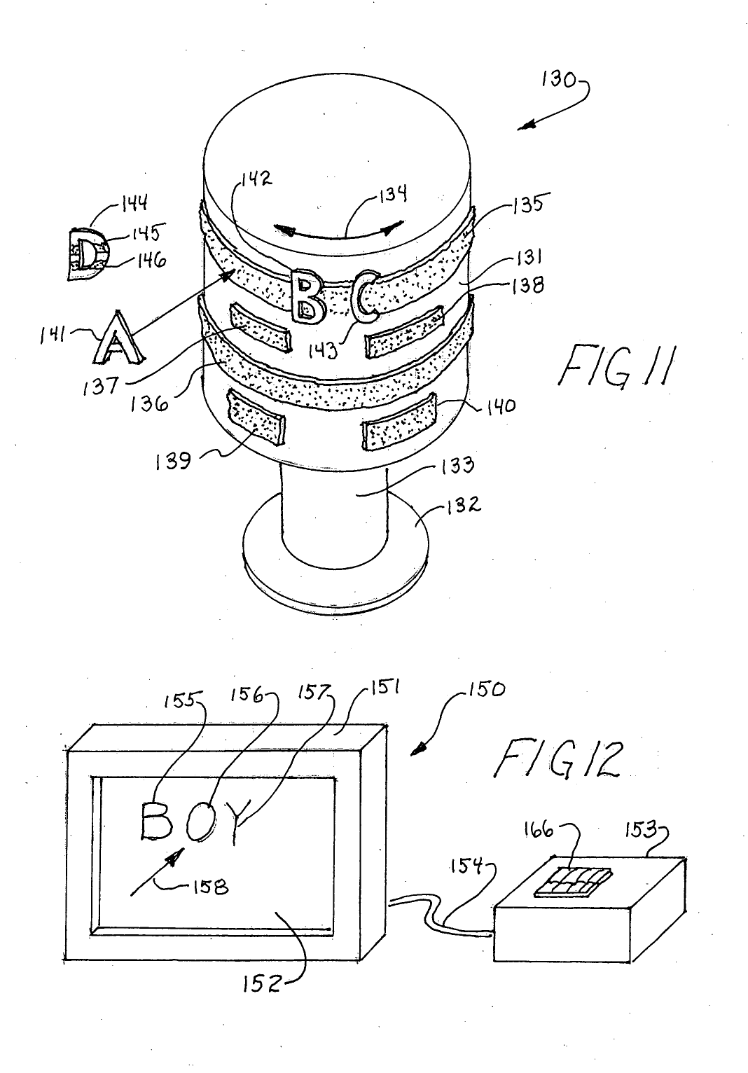

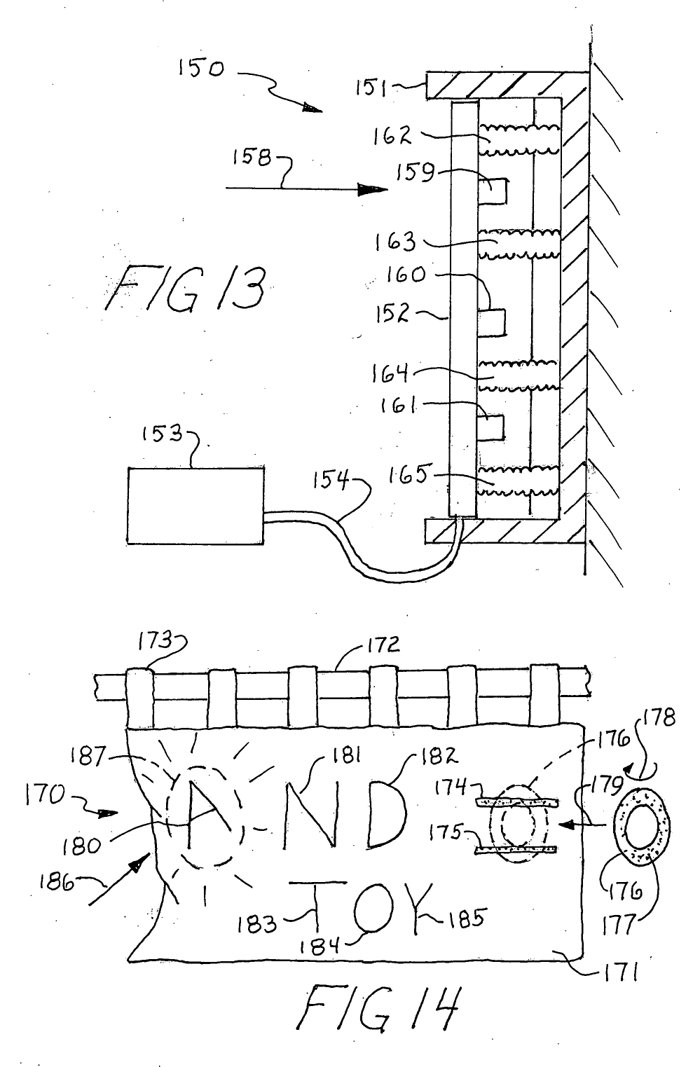

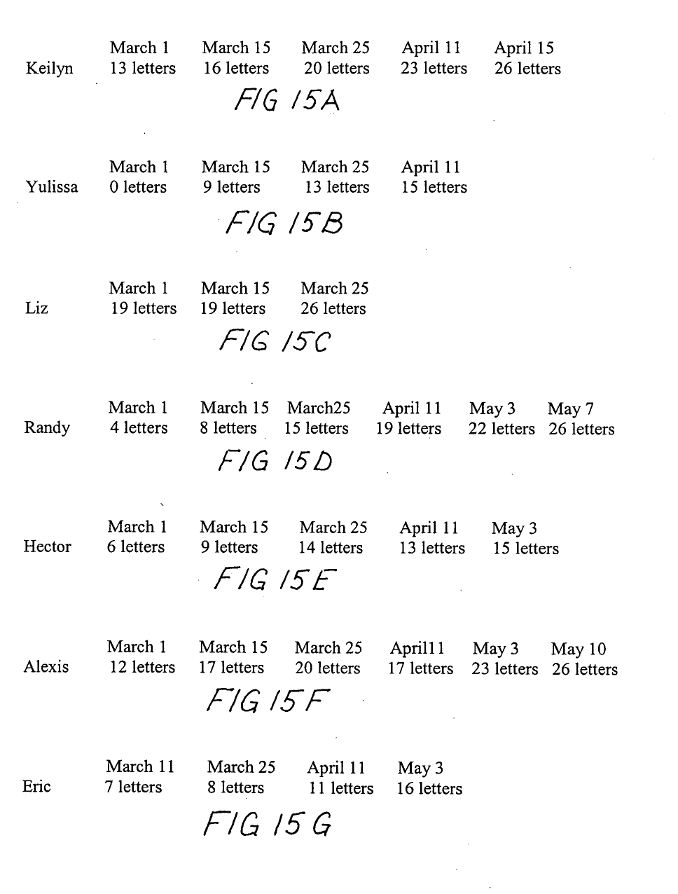

FIGS. 15A through 15G set forth the results of testing the present invention learning system upon a group of kindergarten students each of whom had for different reasons and causes in learning the letters of the alphabet. In each case the student experiencing difficultly was given additional teaching utilizing the present invention apparatus and method. In particular, the students were exposed to the present invention learning method and apparatus utilizing punch drum 110 as shown in FIG. 9. The results for each student (identified by first name only) are set forth in FIGS. 15A through 15G and are correlated to dates of testing and the number of letters which the student has achieved the required level of letter recognition and letter sound capabilities.

FIG. 15A sets forth the results of a student identified as Keilyn who showed great determination in learning her letters but encountered difficulty remembering her letters from one day to the next. The instructor working with Keilyn utilized the apparatus set forth in FIG. 9 and required that the student trace the letters on the punching bag followed by a punching of the selected letter. The instructor had the student voice the letters as they were punched.

FIG. 15B sets forth the results of a student identified as Yulissa for whom English is a second language and who had exhibited great difficulty learning to recognize and sound the letters of the alphabet. The instructor found that Yulissa exhibited great eagerness in the opportunity of working with the punching apparatus of the present invention and quickly learned a substantial number of her letters. The results for Yulissa were interrupted due to a discontinuity in her participation in the tests.

FIG. 15C sets forth the results of participation in the present invention learning system for a student identified as Liz. Liz was a student who had mastered all but seven of her alphabet letters but for some reason had encountered inexplicable difficulty in mastering the recognition and sounds of the remaining seven letters. The instructor worked with Liz utilizing the present invention learning system and apparatus shown in FIG. 9. Within a short space of time, the student was able to master the remaining troublesome seven letters completing her alphabet skills.

FIG. 15D sets forth the results of instruction for a student identified as Randy. Randy was best characterized as the most eager of students always being the first to volunteer for work upon the present invention learning apparatus. The instructor indicated that Randy achieved dramatic progress and was able to master the entire alphabet for letter recognition and sound utilizing the punching bag embodiment of the present invention.

FIG. 15E sets for the results of instruction utilizing the present invention learning system and apparatus for a student identified as Hector. Hector has been characterized as a student who was sometime very hard to motivate. Hector is also characterized as a child who was very quiet in class and reluctant to speak. Hector also resisted participation in teaching programs. Using the present invention learning system, Hector progressed from six letters recognition to fifteen letters as the instruction continues.

FIG. 15F sets forth the results of instruction utilizing the present invention learning method and apparatus for a student identified as Alexis. Alexis has been characterized by the instructor as a student having frequent and multiple absences but none the less exhibited improvement. Alexis is also described as a very active child who particularly enjoyed the punching activities of the present invention system apparatus and who readily mastered all of the alphabet. Alexis is also described as having been motivated to keep punching the letters over and over until they “clicked” for her.

FIG. 15G sets forth the results of instruction utilizing the present invention method and apparatus for a student identified as Eric. Eric is characterized by the instructor as a student who arrived late in the school year and had obtained very low performance results. Eric is also described as a student who required some time to get accustomed to the punching bag of the present invention method and apparatus. Following some early difficulty catching up, Eric is described by the instructor as showing great improvement.

The results of the application of the present invention learning method and apparatus to a randomly selected group of kindergarten students having the common characteristics of the encountering difficulties with letter recognition and sounds is representative of the results obtained by a variety of students exercising in a variety of symbol recognition and learning environments. Of importance with respect to the present invention is the success and improvement realized in this varied group of challenged students utilizing the present invention method and apparatus.

The present invention addresses the learning needs of various types of learners. Auditory learners benefit from the sounds produced, visual learners are able to visualize the letters as they are projected on a wall, and kinesthetic learners are able to carry out physical activity by punching the bag. The multisensory techniques that are utilized by the present invention include: displaying the images of letters, and eventually words, on a screen, which stimulates visual reasoning & learning. The present invention system audibly articulates the letter sounds and later the words that invoke the auditory process which focuses on sound and elicits verbal reasoning. The present invention system causes the learner to coordinate his/her muscle movements by synchronizing his/her movements when punching the punching bag at the appropriate intervals. This in turn applies to the kinesthetic learning, which involves students carrying out fine and gross motor movement and hand-eye coordination. The present invention system requires the learner to touch the punching bag, which stimulates the sense of touch.

Struggling readers often lack phonemic awareness and the ability to decode words. This invention incorporates sounds of letters that make up words, a key component in the development of spelling and reading skills. Being able to manipulate the phonemes or sounds that make up words is a critical piece for struggling readers and spellers. This invention incorporates phonemic awareness practice. Another key component of learning to spell and read that the present invention addresses is phonics or the sound-symbol connection. By connecting the sound to the image of the letter, students develop their phonetic abilities. The English language has over forty phonetic sounds that the present invention is able to address, including vowels, consonants, blends, diphthongs, and digraphs.

The multisensory nature of the present invention deems it advantageous for very young preschoolers through older learners of all abilities and levels. Another attribute is that it can be modified and adapted for all learners by computerizing new subject information such as: math that is customized for each individual. The present invention is a remarkably engaging and educational program that can be formulated for anyone.

What has been shown is a novel and highly effective apparatus and method for teaching students and other learners having learning difficulties. The apparatus and method improve imprinting of symbols such as letters or numbers by combining physical impacting with audible and visual stimuli.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. A method of impact learning activity, said method comprising said steps of
selecting a set of image segments each having a segment name which image segments combine to form a complete image set;
displaying the first image segment of said set for image segments upon an impact responsive display;
punching said first image segment;
sensing an impact of said punching upon said impact responsive display displaying the next image segment of said set of image segments; and
repeating said steps of sensing an impact, and sequentially displaying the next image segment from said set of image segments until said selected set of image segments is completed.

2. The method of impact learning set forth in claim 1 further including the step of:
audibly speaking said name of said image segment as said image segment is punched.

3. The method of impact learning set forth in claim 2 wherein said steps of punching and speaking are repeated multiple times on said first image segment before proceeding said repeating step.

4. The method of impact learning set forth in claim 3 wherein said impact responsive display includes a liquid crystal display and wherein said step of displaying said first image segment includes the step of:
applying a first plurality of image signals to said liquid crystal display to resent said first image segment thereon.

5. The method of impact learning set forth in claim 4 wherein said step of displaying the next image segment includes the step of:
applying a ext plurality of image signals to said liquid crystal display to present said next image segment thereon.

6. The method of impact learning set forth in claim 3 wherein said impact responsive display includes a punching bag having a liquid crystal display supported thereon and wherein said step of displaying said first image segment includes the step of:
applying a first plurality of image signals to said liquid crystal display to present said first image segment thereon.

7. The method of impact learning set forth in claim 6 wherein said step of displaying the next image segment includes the step of:
applying a next plurality of image signals to said liquid crystal display to present said next image segment thereon.

8. The method of impact learning set forth in claim 3 wherein said impact responsive display includes a floor mat having a liquid crystal display supported thereon and wherein said step of displaying said first image segment includes the step of:
applying a first plurality of image signals to said liquid crystal display to present said first image segment thereon.

9. The method of impact learning set forth in claim 8 wherein said step of displaying the next image segment includes the step of:
applying a next plurality of image signals to said liquid crystal display to present said next image segment thereon.

10. The method of impact learning set forth in claim 3 wherein said impact responsive display includes a game unit, a handheld controller and a display having a liquid crystal display supported thereon and wherein said punching step is a simulated punch using said handheld controller and wherein said step of displaying said first image segment includes the step of:
applying a first plurality of image signals to said liquid crystal display to present said first image segment thereon.

11. The method of impact learning set forth in claim 10 wherein said step of displaying the next image segment includes the step of:
applying a next plurality of image signals to said liquid crystal display to present said next image segment thereon.

12. The method of impact learning set forth in claim 3 wherein said impact responsive display includes a rotatable punching bag having a display surface supported thereon and wherein said step of displaying said first image segment includes the step of:
presenting said first image segment on said display surface.

13. The method of impact learning set forth in claim 12 wherein said step of displaying the next image segment includes the step of:
presenting said next image segment on said display surface.

14. The method of impact learning set forth in claim 13 wherein said rotatable punching bag includes a writing surface thereon to form said display surface.

15. The method of impact learning set forth in claim 13 wherein said display surface includes a flexible covering received upon said rotatable punching bag.

16. The method of impact learning set forth in claim 13 wherein said rotatable punching bag includes a fabric attachment surface and a plurality of image segments each having fabric attachment areas and wherein said step of applying a first image segment includes placing one of said image segments upon said fabric attachment surface.
